(19) United States
(12) Patent Application Publication
(10) Pub. No.: US 2025/0010209 A1
(43) Pub. Date: Jan. 9, 2025

(54) STORE UPGRADE METHOD, APPARATUS, AND NON-TRANSITORY COMPUTER-READABLE STORAGE MEDIUM FOR IMPROVED TRANSMISSION EFFICIENCY FOR A TURN-BASED CHESS GAME

(71) Applicant: Tencent Technology (Shenzhen) Company Limited, Shenzhen (CN)

(72) Inventor: Yanan Zhang, Shenzhen (CN)

(21) Appl. No.: 18/890,272

(22) Filed: Sep. 19, 2024

Related U.S. Application Data
(63) Continuation of application No. PCT/CN2023/123217, filed on Oct. 7, 2023.

(30) Foreign Application Priority Data
Nov. 15, 2022 (CN) 2022114290381

(51) Int. Cl. A63F 13/822; A63F 13/5372; A63F 13/69

(52) U.S. Cl. CPC A63F 13/822; A63F 13/5372; A63F 13/69

(57) ABSTRACT

A method for improving transmission efficiency for a turn-based chess game is described herein. The method may include generating, for a battle of a turn-based chess game comprising a first-level store corresponding to a first functional area combination and a second-level store corresponding to a second functional area combination, a first store interface of the first-level store that displays the first functional area combination, a difference between the second functional area combination and the first functional area combination, and a prompt for upgrading the first-level store to unlock the difference, generating a second store interface of the second-level store that displays the difference in the unlocked state, receiving an operation to purchase a first chess piece, and causing to be output the first chess piece in a chess piece candidate area of the battle of the turn-based chess game.

### RELATED APPLICATION

This application is a continuation application of PCT Application PCT/CN2023/123217, filed Oct. 7, 2023, which claims priority to Chinese Patent Application No. 202211429038.1 filed on Nov. 15, 2022, each entitled “STORE UPGRADE METHOD AND APPARATUS FOR TURN-BASED CHESS GAME, DEVICE, AND MEDIUM”, and each which is incorporated herein by reference in its entirety.

### FIELD

One or more aspects described herein relate to the field of human-machine interaction, and in particular, to a store upgrade method, apparatus, device, and non-transitory computer-readable storage medium for a turn-based chess game.

### BACKGROUND

A turn-based chess game is a new type of chess game. After two sides of a battle place chess pieces on a chessboard, a game application automatically controls the chess pieces of the two sides on the chessboard to battle against each other and displays a result of the battle.

In a related technology, in a battle of a turn-based chess game, a user account purchases a chess piece through a store. There are four display positions available in the store and each display position displays a chess piece. A user account can purchase the chess pieces, or can trigger a refresh control of the store to refresh the chess pieces displayed in the four display positions.

A battle of a turn-based chess game is usually very fast, and two sides of the battle need to make a series of decisions about economic operation and chessboard arrangement such as chess piece selection, chess piece purchase, and chess piece arrangement within a very short turn interval. Therefore, information transmission efficiency of an interface is very important.

In the related technology, a store displays four available display positions, and an interface of the store cannot quickly display benefits brought by store upgrade. Therefore, information transmission efficiency of an interface of a store in the related technology is low.

### SUMMARY

One or more aspects described herein provide a store upgrade method, apparatus, device, and non-transitory computer-readable storage medium for a turn-based chess game, which can improve information transmission efficiency of an interface of a store in a turn-based chess game. The technical solutions include but are not limited to the following:

According to an aspect, a store upgrade method for a turn-based chess game is provided. The method may be performed by a terminal, and the method may include: generating, for a battle of a turn-based chess game comprising a first-level store selling chess pieces used in the turn-based chess game and a second-level store selling chess pieces used in the turn-based chess game, a first store interface of the first-level store, wherein the first-level store corresponds to a first functional area combination and the second-level store corresponds to a second functional area combination, and wherein the first store interface displays the first functional area combination in an unlocked state, a difference between the second functional area combination and the first functional area combination in a locked state, and a prompt for upgrading the first-level store to unlock the difference;
causing the first store interface to be output for display;
generating a second store interface of the second-level store in response to an upgrade from the first-level store to the second-level store, the second store interface displaying the difference in the unlocked state;
causing the second store interface to be output for display;
receiving, via the second store interface, an operation to purchase a first chess piece; and
causing to be output, for display and based on the receiving, the first chess piece in a chess piece candidate area of the battle of the turn-based chess game.

According to another aspect, a store upgrade apparatus for a turn-based chess game is provided. The apparatus may include one or more processors and memory storing computer-readable instructions that when executed by the one or more processors, cause the apparatus to:
generate, for a battle of a turn-based chess game comprising a first-level store selling chess pieces used in the turn-based chess game and a second-level store selling chess pieces used in the turn-based chess game, a first store interface of the first-level store, wherein the first-level store corresponds to a first functional area combination and the second-level store corresponds to a second functional area combination, and wherein the first store interface displays the first functional area combination in an unlocked state, a difference between the second functional area combination and the first functional area combination in a locked state, and a prompt for upgrading the first-level store to unlock the difference;
cause the first store interface to be output for display;
generate a second store interface of the second-level store in response to an upgrade from the first-level store to the second-level store, the second store interface displaying the difference in the unlocked state;
cause the second store interface to be output for display;
receive, via the second store interface, an operation to purchase a first chess piece; and
cause to be output, for display and based on the receiving, the first chess piece in a chess piece candidate area of the battle of the turn-based chess game.

According to another aspect, a computer device is provided, the computer device including a processor and a memory, the memory storing at least one instruction, at least one segment of program, a code set, or an instruction set, and the at least one instruction, the at least one segment of program, the code set, or the instruction set being loaded and executed by the processor to implement the store upgrade method for a turn-based chess game according to the foregoing aspect.

According to another aspect, a non-transitory computer-readable storage medium is provided, the computer-readable storage medium storing at least one instruction, at least one segment of program, a code set, or an instruction set, and the at least one instruction, the at least one segment of program, the code set, or the instruction set being loaded and executed by a processor to implement the store upgrade method for a turn-based chess game according to the foregoing aspect.

According to another aspect, a computer program product or a computer program is provided, including a computer instruction stored in a computer-readable storage medium. A processor of a computer device reads the computer instruction from the computer-readable storage medium, and the processor executes the computer instruction, so that the computer device performs the store upgrade method for a turn-based chess game.

The technical solutions provided in the one or more aspects described herein have at least the following beneficial effects:

The store is displayed as the functional area combination corresponding to the next-level store, the difference between the functional area combinations of the current-level store and the next-level store is displayed in the locked state, and after the store is upgraded to the next level, the difference is unlocked and displayed. The store level and some of benefits brought by change in the store level are intuitively displayed through the display style of the store interface. Moreover, some of benefits that may be brought by the next-level store may be displayed in advance, which greatly improves the information transmission efficiency of the store interface to adapt to the fast battle of the turn-based chess game.

### BRIEF DESCRIPTION OF THE DRAWINGS

FIG. 1 is a schematic diagram of one or more aspects of a turn-based chess game;

FIG. 2 is a structural block diagram of one or more aspects of a computer system for a turn-based chess game;

FIG. 3 is a flowchart of one or more aspects of a store upgrade method for a turn-based chess game;

FIG. 4 is a schematic diagram of one or more aspects of an interface of a store upgrade method for a turn-based chess game;

FIG. 5 is a schematic diagram of one or more aspects of an interface of a store upgrade method for a turn-based chess game;

FIG. 6 is a schematic diagram of one or more aspects of an interface of a store upgrade method for a turn-based chess game;

FIG. 7 is a flowchart of one or more aspects of a store upgrade method for a turn-based chess game;

FIG. 8 is a schematic diagram of one or more aspects of a display position of a store upgrade method for a turn-based chess game;

FIG. 9 is a flowchart of one or more aspects of a store upgrade method for a turn-based chess game;

FIG. 10 is a schematic diagram of one or more aspects of a display position of a store upgrade method for a turn-based chess game;

FIG. 11 is a schematic diagram of one or more aspects of a display position of a store upgrade method for a turn-based chess game;

FIG. 12 is a flowchart of one or more aspects of a store upgrade method for a turn-based chess game;

FIG. 13 is a flowchart of one or more aspects of a store upgrade method for a turn-based chess game;

FIG. 14 is a block diagram of one or more aspects of a store upgrade apparatus for a turn-based chess game; and

FIG. 15 is a block diagram of one or more aspects of a terminal for a turn-based chess game.

### DETAILED DESCRIPTION

First, several terms used to describe one or more aspects of a turn-based chess game are described below.

Turn-based chess game: A turn-based chess game refers to a chess game in which “chess pieces” may be pre-arranged before a chess battle, and during the battle, the “chess pieces” may automatically battle against each other according to the pre-arrangement. “Chess pieces” may be represented by virtual characters. During a battle, the virtual characters automatically may release various skills to battle. Battles may be turn-based. When all “chess pieces” of one side in the battle are killed (that is, life values of the virtual characters are reduced to zero), this side may be the loser of the battle of the current turn. In addition to having “chess piece-type virtual characters” for playing a game, two sides of a battle may also have virtual characters representing users participating in the battle. The virtual character may not be moved to a battle area or a chess piece candidate area as a “chess piece”. The virtual character may also be provided with a life value (or a blood volume). The life value of the virtual character may be reduced (the battle fails) or stays unchanged (the battle succeeds) according to a result of each battle. When the life value of the virtual character is reduced to zero, the user corresponding to the virtual character may exit the battle, and the remaining users continue to battle. A turn-based chess games may include auto chess.

Auto chess: Auto chess is an eight-player turn-based competitive game with collectible hero cards in a battle. There may be a total of eight players in the game, and each player may occupy a chessboard. Each turn may include two stages: a preparation phase and a battle phase: In the preparation phase, a user may purchase chess pieces (heroes) in a store and may make arrangement on a chessboard. In the battle phase, lineups of two sides may be locked, and chess pieces may automatically battle until all chess pieces on one side are dead. A player whose chess pieces are all destroyed may be the loser of the current turn, and a specific amount of blood may be deducted. Game turns may be repeated continuously and new opponents may be matched until a life value of a player is ≤0 and the player is eliminated. The last remaining player wins the game (ranked in the first place).

Chessboard: A chessboard refers to an area in a battle interface of a turn-based chess game used to prepare for and conduct battles. The chessboard may be a two-dimensional virtual chessboard, a 2.5-dimensional virtual chessboard, and a three-dimensional virtual chessboard, and is not limited.

The chessboard may be divided into a battle area and a chess piece candidate area. The battle area may include several battle chess grids of the same size, and the battle chess grids may be configured for placing battle chess pieces for the battle during the battle. The chess piece candidate area may include several candidate chess piece positions, and the candidate chess piece positions may be configured for placing candidate chess pieces. The candidate chess pieces do not participate in a battle during the battle and may be dragged and placed in the battle area in the preparation phase. Battle chess pieces may include chess pieces located in the battle area and chess pieces located in the chess piece candidate area.

Regarding an arrangement manner of chess grids in the battle area, the battle area may include n (rows)×m (columns) battle chess grids. For example, n may be an integer multiple of 2, and two adjacent rows of chess grids may be aligned, or two adjacent rows of chess grids may be staggered. In addition, the battle area may be evenly divided into two parts according to rows, that is, a self battle area and an enemy battle area. Users participating in the battle may be located on the upper and lower sides of the battle interface. In the preparation phase, users may only place chess pieces in the self battle area. In one example, the battle area may be evenly divided into two parts according to columns, that is, a self battle area and an enemy battle area, and users participating in the battle may be located on the left and right sides of the battle interface. A shape of the battle chessboard may be square, rectangle, circle, or hexagon and is not otherwise limited.

The battle chess grid may be displayed on the chessboard. The battle chess grid may be displayed when the user arranges the battle chess pieces. After the battle chess pieces are placed on the chess grid, the battle chess grid may no longer be displayed.

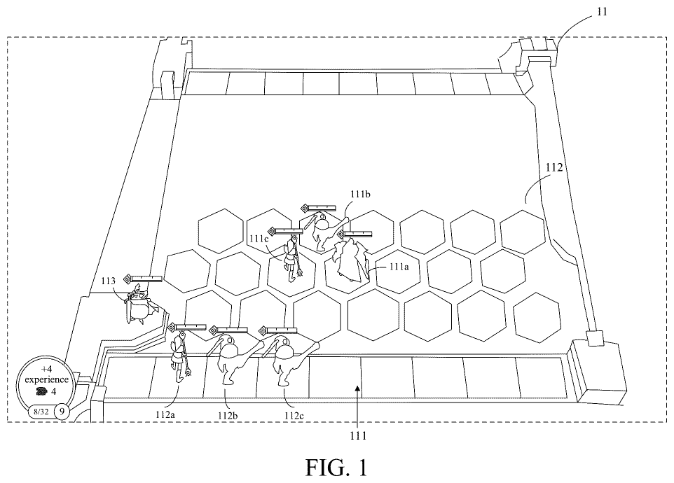

For example, as shown in FIG. 1, a battle chessboard 11 in the battle interface may include a chess piece candidate area 111 and a battle area 112. The self battle area in the battle area 112 may include 3×7 battle chess grids, the shape of the chess grid may be hexagonal, two adjacent rows of chess grids may be staggered, and the chess piece candidate area 111 may include 9 candidate chess piece positions.

Virtual character: A virtual character refers to a chess piece placed on a chessboard in a turn-based chess game, and may include a battle chess piece and a chess piece sold in a store. The battle chess piece may include a chess piece located in a battle area and a chess piece located in a chess piece candidate area. The virtual character may be a virtual chess piece, a virtual character, a virtual animal, an animation character, or the like, and the virtual character may be displayed using a three-dimensional model. After a user purchases a chess piece sold in a store, the purchased chess piece may be combined with an existing battle chess piece of the user to trigger an enhanced battle effect, or may participate in the chess game as a battle chess piece.

A position of the battle chess piece on the chessboard may be changed. In the preparation phase, a user may adjust a position of a chess piece in the battle area, adjust a position of a chess piece in the chess piece candidate area, move a chess piece in the battle area to the chess piece candidate area (when there is an available candidate chess piece position in the chess piece candidate area), or move a chess piece in the chess piece candidate area to the battle area. In the battle phase, a position of a chess piece in the chess piece candidate area may also be adjusted.

The position of the chess piece in the battle area in the battle phase may be different from that in the preparation phase. For example, in the battle phase, the chess piece may automatically move from the self battle area to the enemy battle area and attack an enemy chess piece. Alternatively, the chess piece may automatically move from a position A in the self battle area to a position B in the self battle area.

In addition, in the preparation phase, the chess piece may only be set in the self battle area, and a chess piece set by the enemy is invisible on the chessboard.

Regarding obtaining a battle chess piece, the user may purchase a chess piece in a store with a gold coin in the preparation phase in a game.

Virtual characters may be used to represent users participating in a battle. The virtual characters may be virtual characters, virtual animals, animation characters, and/or the like. These virtual characters may be referred to as “player virtual characters” or “user virtual characters.”

For example, as shown in FIG. 1, the battle area 112 may display a first battle chess piece 111a, a second battle chess piece 111b, and a third battle chess piece 111c, and the chess piece candidate area 111 may display a first candidate chess piece 112a, a second candidate chess piece 112b, and a third candidate chess piece 112c. A player virtual character 113 may be displayed next to the battle area and the chess piece candidate area.

Attribute: Each chess piece in a turn-based chess game may have an attribute, and the attribute may include at least two of the following attributes: a camp of a chess piece (for example, alliance A, alliance B, and/or neutral faction), a type of a chess piece (for example, warrior, shooter, master, assassin, guard, swordsman, gunner, and/or fighter), an attack type of a chess piece (for example, magic and/or physical), an identity of a chess piece (for example, noble, demon, and/or fairy), and the like. The specific types of attributes are not limited.

Each chess piece may have attributes in at least two dimensions, and equipment carried by the chess piece may improve the attributes of the chess piece.

In the battle area, when different chess pieces have associated attributes (including different chess pieces having the same attribute, or different chess pieces having complementary attributes), and a number reaches a number threshold (or referred to as a bond), the pair of chess pieces with these attributes or all the chess pieces in the battle area may obtain the corresponding gain effect of these attributes. For example, when the battle area includes two chess pieces with the warrior attribute, all battle chess pieces obtain 10% defense enhancing. When the battle area includes four chess pieces with the warrior attribute, all battle chess pieces obtain 20% defense enhancing. When the battle area includes three chess pieces with the fairy attribute, all battle chess pieces obtain 20% dodge probability enhancing.

Store: A store is a place in which users may spend gold coins (virtual gold coins) in a game to buy chess pieces (heroes) in the game, and is also referred to as a virtual store. Generally, 5 random heroes (repeatable) may be displayed in the store. Stores may be distinguished by levels. A higher level may indicate a higher probability of refreshing a high-grade hero. An initial level may be 1 to 3 (levels of different auto chess games are different), and users may spend gold coins to upgrade the store.

User interface (UI) control: A user interface control is a visible control or element or an invisible control or element on a user interface of an application program, such as picture, input box, text box, button, and label. For example, when the UI control is an invisible control, a user may trigger the invisible control by triggering a specified area on the user interface. Some UI controls may respond to user operations, for example, purchase controls may be used to respond to user purchase operations to purchase corresponding chess pieces. An upgrade control may be configured for upgrading a store. UI controls involved in the one or more aspects described herein include but are not limited to: purchase controls and/or upgrade controls.

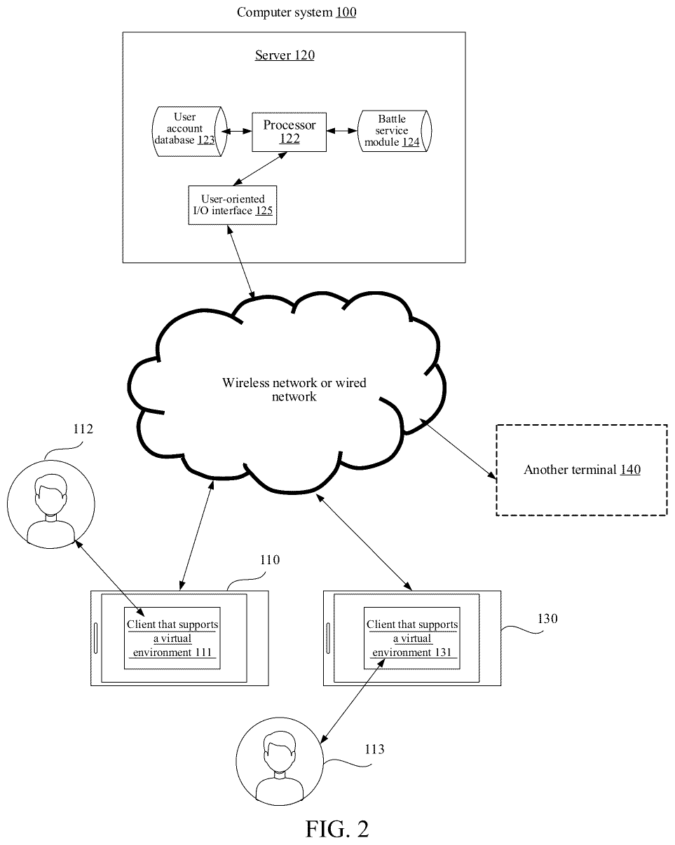

FIG. 2 is a structural block diagram of one or more aspects of a computer system for a turn-based chess game. The computer system 100 may include: a first terminal 110, a server 120, and/or a second terminal 130.

The first terminal 110 may install and run a client 111 that may support a virtual environment. The client 111 may be a turn-based chess game program. When the first terminal runs the client 111, a user interface of the client 111 may be displayed on the screen of the first terminal 110. The client may be a client of an auto chess game. The first terminal 110 for a turn-based chess game a terminal used by a first user 112. In a preparation stage of a game, the first user may use the first terminal 110 to arrange battle chess pieces in a battle area of a chessboard. In a battle stage, the first terminal 110 or the server 120 may automatically control, based on attributes, skills, and/or arrangements of the battle chess pieces in the battle area, the battle chess pieces to battle against each other.

The second terminal 130 may install and run a client 131 that supports a virtual environment. The client 131 may be a turn-based chess game program. When the second terminal 130 runs the client 131, a user interface of the client 131 may be displayed on the screen of the second terminal 130. The client may be a client of an auto chess game. The second terminal 130 for a turn-based chess game a terminal used by a second user 113. In a preparation stage of a game, the second user may use the second terminal 130 to arrange battle chess pieces in a battle area of a chessboard. In a battle stage, the second terminal 130 or the server 120 may automatically control, based on attributes, skills, and/or arrangements of the battle chess pieces in the battle area, the battle chess pieces to battle against each other.

Battle chess pieces arranged by the first user through the first terminal 110 and by the second user through the second terminal 130 may be located in different battle areas on the same chessboard, that is, the first user and the second user may be on the same chessboard in the same game. Alternatively, battle chess pieces arranged by the first user through the first terminal 110 and by the second user through the second terminal 130 may be located on different chessboards, that is, the first user and the second user may be on different chessboards in the same game. For example, a battle of a turn-based chess game Alternatively played by eight user accounts. In each turn, eight user accounts matched in pairs. Two user accounts that are matched may battle against each other on the same chessboard in the current turn.

The clients installed on the first terminal 110 and the second terminal 130 Alternatively the same, or the clients installed on the two terminals Alternatively the same type of clients on different operating system platforms (Android or IOS). The first terminal 110 may generally refer to one terminal of a plurality of terminals, and the second terminal 130 may generally refer to another terminal of the plurality of terminals. The first terminal 110 and the second terminal 130 are only used as an example. Device types of the first terminal 110 and the second terminal 130 Alternatively the same or different. The device types may include: at least one of a smart phone, a tablet computer, an E-book reader, an MP3 player, an MP4 player, a laptop computer, a desk computer, a smart phone, and/or the like.

A person skilled in the art would understand that the number of the above terminals may be more or less. For example, there may be only one terminal (that is, a user battles against artificial intelligence), or there may be 8 terminals (1v1v1v1v1v1v1v1, that is, 8 users battle against and eliminate each other in a round-robin manner, to finally determine a winner), or more terminals. A number and device types of terminals are not limited.

Only two terminals are shown in FIG. 2, but one or more additional terminals (not shown) may access the server 120. There may also be one or more terminals 140 that correspond to developers. A development and editing platform for a client that supports a virtual environment may be installed on the terminal 140. A developer may edit and update the client on the terminal 140, and transmit an updated client installation package to the server 120 through a wired or wireless network. The first terminal 110 and the second terminal 130 may download the client installation package from the server 120 to update the client.

The first terminal 110, the second terminal 130, and the another terminal 140 may be connected to the server 120 through a wireless or wired network. The server 120 may include at least one of one server, a plurality of servers, a cloud computing platform, and/or a virtualization center. The server 120 may be configured to provide a background service for a client that supports a three-dimensional virtual environment (a client of a turn-based chess game/a client of an auto chess game). The server 120 may be responsible for primary computing work, and the terminal may be responsible for secondary computing work. Alternatively, the server 120 may be responsible for secondary computing work, and the terminal may be responsible for primary computing work. Alternatively, a distributed computing architecture may be used between the server 120 and the terminal for collaborative computing.

In one example, the server 120 may include a processor 122, a user account database 123, a battle service module 124, and/or a user-oriented input/output interface (I/O interface) 125. The processor 122 may be configured to load an instruction stored in the server 120 and process data in the user account database 123 and the battle service module 124. The user account database 123 may be configured to store data of user accounts used by the first terminal 110, the second terminal 130, and the another terminal 140, such as avatars of the user accounts, nicknames of the user accounts, battle strength indexes of the user accounts, and service areas of the user accounts. The battle service module 124 may be configured to provide a plurality of battle rooms for users to battle. The user-oriented I/O interface 125 may be configured to establish communication and exchange data with the first terminal 110 and/or the second terminal 130 through a wireless network or a wired network.

With reference to the above description of the turn-based chess game and the description of the implementation environment, the store upgrade method for a turn-based chess game are described below. The method may be performed by the terminal shown in FIG. 1 or the client running on the terminal. The client running on the terminal may be a client of an application program, and the application program may be a program for a turn-based chess game.

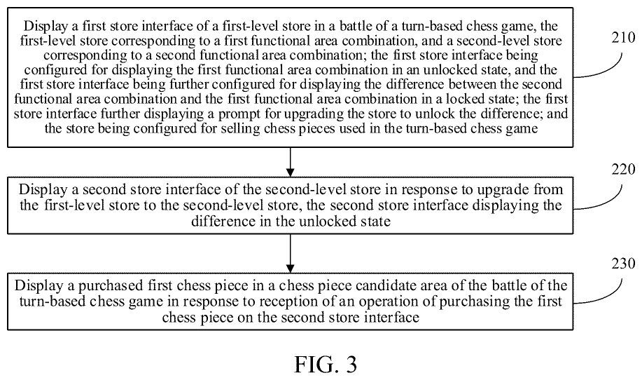

FIG. 3 is a flowchart of one or more aspects of a store upgrade method for a turn-based chess game. The method may be performed by any terminal in FIG. 2 or a client running on any terminal, and the client may be a client of a turn-based chess game. The method may include:

Operation 210: Display a first store interface of a first-level store in a battle of a turn-based chess game. The first-level store may correspond to a first functional area combination. The turn-based chess game may further include a second-level store corresponding to a second functional area combination. The first store interface may be configured for displaying the first functional area combination in an unlocked state, and displaying a difference between the second functional area combination and the first functional area combination in a locked state. The first store interface may further display a prompt for upgrading the store to unlock the difference. The store may be configured for selling chess pieces used in the turn-based chess game.

The store may be an in-battle store in the battle of the turn-based chess game and may be configured for purchasing chess pieces used in the battle of the turn-based chess game. The store may have a specific number of display positions, and each display position may display a chess piece for sale. The store may have a refresh control. In response to triggering of the refresh control, chess pieces sold in the store may be obtained by refresh and displayed. In in each refresh, chess pieces displayed in all display positions in the store may be obtained by refresh, that is, a first batch of chess pieces may be displayed before the refresh, and a second batch of chess pieces may be displayed after the refresh. Certainly, this does not exclude that the first batch of chess pieces and the second batch of chess pieces may include the same chess pieces.

The store may have a store level and the store level may affect a store attribute. For example, the store attribute may include at least one of a number of display positions, a chess piece refresh probability, a store discount, a chess piece sale price, a chess piece type, an experience point required for store upgrade, and/or a store display style. A number of available chess pieces displayed in the store may depend on the number of display positions. If the number of display positions is 4, 4 chess pieces may be displayed in the store at the same time. Users may choose and purchase chess pieces from the 4 chess pieces. Each time the store is refreshed, the 4 chess pieces may be refreshed and 4 new chess pieces may be displayed. If the number of display positions is 6, 6 chess pieces may be displayed in the store at the same time. Users may choose and purchase chess pieces from the 6 chess pieces. Each time the store is refreshed, the 6 chess pieces may be refreshed and 6 new chess pieces may be displayed. That is, more display positions may indicate more chess pieces that a user may choose to buy, and a higher probability of refreshing to obtain a chess piece that the user wants to buy. The number of display positions may have a positive correlation with the store level. For example, the store level may be attribute information of the virtual store. In an implementation, the store may be a store in a virtual battle. After the virtual battle is entered, the store may have an initial store level, such as a level 2. Further, after a current virtual battle may be ended or exited and a new virtual battle may be entered, the store level of the store may be updated to the initial store level. For example, the store level of the store may be attribute information that may be independent of other level information in the game. For example, the store level of the store may not be associated with a growth level of a virtual character or a proficiency level of a virtual identity.

An example of a correspondence between a store level and a number of display locations is shown in Table 1.

TABLE 1

| Store level | Number of display positions |
|---|---|
| 2 | 4 |
| 3 | 4 |
| 4 | 4 |
| 5 | 5 |
| 6 | 5 |
| 7 | 5 |
| 8 | 6 |

As shown in Table 1, the initial level of the store in the battle may be the level 2, and the number of display positions may be 4. When the store level is upgraded to a level 5, the number of display positions may be unlocked to reach 5. When the store level is upgraded to a level 8, the number of display positions may be unlocked to reach 6.

The chess piece refresh probability may include an appearance probability of each chess piece in the store, or an appearance probability of each type of chess piece in the store, or an appearance probability of each grade of chess piece in the store. That is, a probability value of a chess piece/a type of chess piece/a grade of chess piece may be obtained after the store is refreshed. For example, for the first-level store, each chess piece may correspond to an appearance probability, or each type of chess piece (this type may be based on any dimension of a virtual camp of the chess piece, a type of a virtual volume occupied by the chess piece, a type of an attack skill of the chess piece, a virtual identity of the chess piece, and/or the like) may correspond to an appearance probability, or each grade of chess piece may correspond to an appearance probability. The grade may be a type of attribute information of the chess piece. The grade of the chess piece may also be understood as a virtual level of the chess piece. A higher grade of a chess piece may indicate a stronger capability of the chess piece in various aspects (for example, at least one of a virtual attack power, a virtual life value, and a virtual defense value). For example, an appearance probability of the first-grade chess piece in the first-level store may be 90%, and an appearance probability of the first-grade chess piece in the second-level store may be 30%.

The store level may also correspond to a store discount. A higher store level may indicate a higher store discount. A gold coin price that a user account needs to pay when purchasing a chess piece may be an original price of the chess piece multiplied by the store discount. In this way, in a high-level store, a user account may use fewer gold coins to purchase the same chess piece. The same chess piece may also have different sale prices (chess piece sale prices) in stores of different levels. Alternatively, a chess piece of the same type/grade may have different chess piece sale prices in stores of different levels. For example, a sale price of the first-grade chess piece in the first-level store may be 5 gold coins, and a sale price of the first-grade chess piece in the second-level store may be 3 gold coins. Types of chess pieces available for sale in stores of different levels may also be different. For example, the first-level store may sell the first-grade chess piece, and the second-level store may sell the first-grade chess piece and the second-grade chess piece. Types of chess pieces available for sale in the store may also be implemented by adjusting the chess piece refresh probability. For example, if a chess piece refresh probability of a type of chess piece in a store of a specific level is set to 0, this type of chess piece may not appear in the store of this level.

Different levels of stores may require different experience points for upgrade. For example, experience points required to upgrade the first-level store to the second-level store may be 5, and experience points required to upgrade the second-level store to the third-level store may be 10. Experience points required for store upgrade may be positively correlated to the store level.

Different levels of stores may have different store display styles. The store display style may include, but is not limited to, a frame style, an interface color, an interface size, a number of display positions, and/or a style of display positions.

The first-level store may be a store whose store level is the first level. The first level may be a store level. For example, the first level may be any one of a level 3, a level 4, and a level 5. Similarly, the second level and the third level in the second-level store and the third-level store may also be store levels. The second-level store may be better than the first-level store, and the third-level store may be better than the second-level store, that is, the second level may be higher than the first level, and the third level may be higher than the second level.

Stores of different levels may correspond to respective functional area combinations. For example, the first-level store may correspond to a first functional area combination, and the second-level store may correspond to a second functional area combination. The functional area combination may include one or more functional areas. For example, the functional area may be a functional area configured for indicating transaction information of chess pieces displayed on a store interface, and/or a functional area configured for indicating decorative information on a store interface. For example, the functional area combination may be configured for indicating at least one of a store display location, a store frame style, a store interface size, and/or a price of a chess piece in the store.

The store interface of the current-level store may be configured for displaying the functional area combination corresponding to the current-level store in an unlocked state, and displaying a difference between a next-level functional area combination and the current-level functional area combination in a locked state. In this way, the user may see the functional area combination of the current-level store and the functional area combination of the next-level store, and the functional area combination that may be unlocked after upgrading the store level may be informed in advance to guide the user to upgrade the store.

The first-level store may correspond to a first functional area combination, and a second-level store may correspond to a second functional area combination.

The difference between the next-level functional area combination and the current-level functional area combination may include, but is not limited to, at least one of the following: a frame style difference, an interface color difference, an interface size difference, a difference between numbers of display positions, a difference between styles of display positions, and/or a chess piece sale price difference. Display of the difference in the locked state is described below.

In a case that the first functional area combination includes a first number of display positions, and the second functional area combination includes the first number of display positions and a second number of display positions, the second number of display positions may be displayed in the locked state. The second number of display positions may be the difference. A display position displayed in the locked state may not display a chess piece for sale. A display position displayed in the locked state may not respond to a user purchase operation. The first number of display positions included in the first functional area combination may be displayed in the unlocked state, and the display positions displayed in the unlocked state display chess pieces for sale. A display position displayed in the unlocked state may respond to a user purchase operation.

When a frame style of the second functional area combination is adding a frame to a frame style of the first functional area combination, the added frame may be displayed in grey. When the frame style of the second functional area combination is completely different from the frame style of the first functional area combination, the frame style of the first functional area combination may be displayed in the unlocked state, for example, the frame style of the first functional area combination may be displayed in color. The frame style of the second functional area combination may be displayed in the locked state around the frame style of the first functional area combination, for example, the frame style of the second functional area combination may be displayed in grey.

When there is a difference between interface sizes of the first functional area combination and the second functional area combination, display may be based on the size of the second functional area combination. The interface size corresponding to the first functional area combination may be displayed in the unlocked state (for example, displayed in color), and the interface size corresponding to the second functional area combination may be displayed in the locked state (for example, displayed in grey).

When there is a difference between display position styles of the first functional area combination and the second functional area combination, the display positions (the first number of display positions) included in the first functional area combination may be displayed in a first display position style (a display position style corresponding to the first functional area combination). Extra display positions in the second functional area combination (the second number of display positions) may be displayed in a second display position style (a display position style corresponding to the second functional area combination).

When the first chess piece for sale is displayed on the first store interface, and a first price of the first chess piece for sale in the first-level store is different from a second price of the first chess piece for sale in the second-level store, the first price and the second price of the first chess piece may be displayed on the first store interface, where the first price may be displayed in the unlocked state and the second price may be displayed in the locked state. For example, the second price may be displayed in color and the second price may be displayed in grey. Alternatively, the first price may be displayed with high brightness and the second price may be displayed with low brightness. Alternatively, a lock sign may be displayed on the second price.

In an example, the first functional area combination may be a subset of the second functional area combination. For example, at least one of the following cases may exist: a number of store display positions indicated by the first functional area combination may be less than that of the second functional area combination; pattern color complexity of a store frame style indicated by the first functional area combination may be lower than that of the second functional area combination; a size of a store interface indicated by the first functional area combination may be smaller than that of the second functional area combination, and a chess piece price in the store indicated by the first functional area combination may be higher than that of the second functional area combination.

An unlock prompt may be further displayed for the difference on the first store interface, and the unlock prompt may include at least one of a text prompt, an icon prompt, and/or an animation prompt. For example, a text prompt indicating “unlock the second-level store” may be displayed near/on the difference. Alternatively, a to-be-unlocked animation may be displayed on the difference. Alternatively, an icon for unlocking the second-level store may be displayed on the difference.

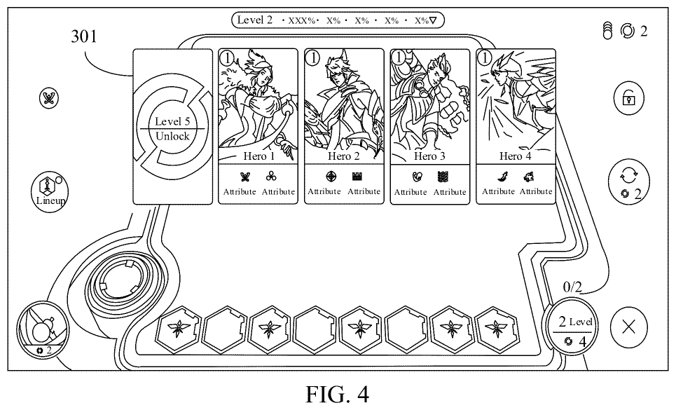

For example, as shown in FIG. 4, the first store interface may display the second functional area combination. The first functional area combination may include 4 display positions, and the second functional area combination may include 5 display positions. Then, the difference between the first functional area combination and the second functional area combination may include a first display position 301, the first display position 301 may be displayed in the locked state on the first store interface, and a prompt “unlock level 5” may be displayed on the first display position 301.

A store interface (including, but not limited to, the first store interface and/or the second store interface) of the store may be displayed in the form of a pop-up window on the battle interface (an interface including the chessboard). For example, the 5 display positions in FIG. 4 may be the store interface, and the store interface may be displayed on the battle interface. The store interface may also be displayed as a separate interface (covering the entire display screen).

Operation 220: Display a second store interface of the second-level store in response to upgrade from the first-level store to the second-level store, the second store interface displaying the difference in the unlocked state.

When the store is upgraded from the first-level store to the second-level store, the first store interface may be refreshed to display the second store interface corresponding to the second-level store. That is, when the store level is upgraded, the first store interface may be immediately refreshed to display the second store interface. Immediately refreshing means that regardless of the current stage (including the battle stage and the preparation stage) of the battle, the store may be immediately refreshed to display the second-level store. Operation 220 may be implemented as the following sub-operations:

Sub-operation 20a: When the store is upgraded from the first-level store to the second-level store, refresh the first store interface to display the second store interface corresponding to the second-level store.

Sub-operation 20a may be combined with operation 210 and operation 230 to form an additional aspect, which may be implemented independently. This is not limited.

Each time a battle ends (that is, when entering a preparation stage of a next battle), the store interface may be automatically refreshed for free once. Then, if a user upgrades the store level during the battle, the user may immediately refresh the store for free once and obtain a new batch of chess pieces. Then, after the current battle is over, the store may be automatically refreshed again. In this way, users may view two batches of chess pieces obtained by refresh according to high-level stores for free, improving the probability of users obtaining desired chess pieces. Except for automatic store refresh, users may need to consume gold coins to refresh the store manually.

The displaying the difference in the unlocked state may include:

based on a determination that that the first functional area combination includes a first number of display positions, and the second functional area combination includes the first number of display positions and a second number of display positions, unlocking the second number of display positions on the first store interface, to obtain the second store interface of the second-level store. Operation 220 may be implemented as the following sub-operations:

Sub-operation 20b: Unlock the second number of display positions on the first store interface in response to upgrade from the first-level store to the second-level store, to obtain the second store interface of the second-level store.

Sub-operation 20b may be combined with operation 210 and operation 230 to form an additional aspect, which may be implemented independently. This is not limited. For example, the second number of display positions may be displayed in the unlocked state in the second store interface. The display positions displayed in the unlocked state may display chess pieces for sale. A display position displayed in the unlocked state may respond to a user purchase operation. The second store interface may include the first number of display positions plus the second number of display positions in the unlocked state.

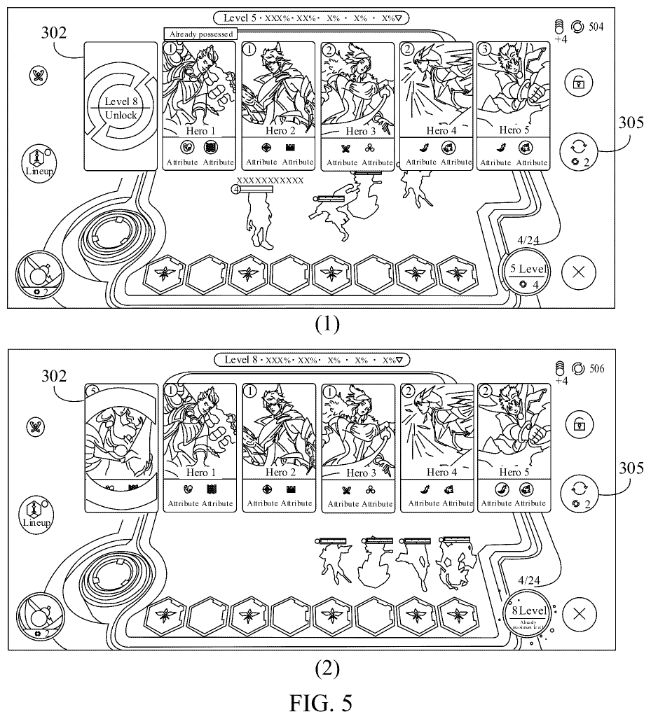

For example, (1) in FIG. 5 shows a first store interface, and the first store interface may display a second functional area combination of a second-level store (a store of a level 8). The second functional area combination may include 6 display positions, the first functional area combination may include 5 display positions, and the difference between the two functional area combinations may be a second display position 302. The first store interface may display the second display position 302 in the locked state, and the second display position may display a lock sign and prompt information “unlock level 8”, and may display no chess piece for sale. When a store is upgraded from a first-level store (a store of a level 7) to a second-level store (a store of a level 8), as shown in (2) in FIG. 5, the store interface may be immediately refreshed and an unlock animation may be displayed in the second display position 302. As the unlock animation plays, the second display position 302 may be gradually unlocked, and a chess piece for sale may appear gradually on the second display position 302. When the store level is upgraded, chess pieces displayed on the original display positions (the original 5 display positions in the figure, that is, the first number of display positions) may be refreshed accordingly.

When a frame style of the second functional area combination is adding a frame to a frame style of the first functional area combination, the added frame may be gradually displayed from grey to an original color. When the frame style of the second functional area combination is completely different from the frame style of the first functional area combination, the display of the frame style of the first functional area combination may be canceled, and the frame style of the second functional area combination in grey may be gradually displayed in the original color.

When there is a difference between display position styles of the first functional area combination and the second functional area combination, the display positions (the first number of display positions) included in the first functional area combination may be changed from a first display position style (a display position style corresponding to the first functional area combination) to a second display position style (a display position style corresponding to the second functional area combination). Extra display positions in the second functional area combination (the second number of display positions) may still be displayed in the second display position style.

When a first chess piece for sale is displayed on the first store interface, and a first price of the first chess piece for sale in the first-level store is different from a second price of the first chess piece for sale in the second-level store, display of the first price of the first chess piece may be canceled, and the second price may be displayed in the unlocked state. For example, the second price may be displayed in the original color. Alternatively, the second price may be highlighted. Alternatively, display of the lock sign of the second price may be canceled.

The store may have experience points. As the experience points increase, the store level may be upgraded. For example, when the store experience point reaches 100, the store level may be upgraded to the second level, and when the store experience point reaches 300, the store level may be upgraded to the third level. Alternatively, each store level may correspond to an experience progress bar. When the experience progress bar is full, the store level may be upgraded. For example, the experience progress bar of the second-level store may be 200 experience points. When 200 experience points are obtained, the second-level store may be upgraded to a third-level store, and an experience progress bar of the third-level store may be displayed.

The store level may be upgraded with the number of chess pieces purchased by the user account. For example, when the number of chess pieces purchased by the user reaches 5, the store level may be upgraded from the first level to the second level.

Optionally, the store level may be upgraded with a total battle duration/a number of turns. For example, when the total battle duration reaches 5 minutes, the store level may be upgraded from the first level to the second level. Alternatively, when a number of turns of the current battle reaches the second turn, the store level may be upgraded from the first level to the second level.

For example, a terminal device/a server may control the store to automatically upgrade from the first-level store to the second-level store. For example, after each turn of battle is ended, 2 store experience points may be automatically obtained. When the store experience points meet an upgrade condition, the store level may be automatically upgraded to the second level.

For example, the terminal device may also control the store to be upgraded from the first-level store to the second-level store in response to a user operation. For example, the terminal device may increase the store experience point in response to an operation of purchasing the store experience point by a user, and may control the store level to be upgraded from the first level to the second level in response to that the store experience point meets the upgrade condition. Alternatively, the terminal device may control the store to be upgraded from the first-level store to the second-level store in response to an operation of upgrading the store by a user.

In one example, the store level may be upgraded only during a turn interval, that is, the store level may be upgraded only after a turn is ended and before a next turn begins. Alternatively, the store level may be upgraded only during a battle interval, that is, the store level may be upgraded only after a current turn of battle is ended and before a next turn of battle begins. Alternatively, there is no time limit for upgrading the store level, that is, the store level may be upgraded at any time (including during a battle and during a turn).

For example, the difference between the second store interface and the first store interface is that the difference may be displayed in the unlocked state. Except for the difference that is differently displayed, the remaining parts of the second store interface and the first store interface may have the same display style (the same display style herein does not include the same chess piece for sale).

When the third functional area combination corresponding to the third-level store is different from the second functional area combination, the second store interface may also display the difference between the third functional area combination and the second functional area combination.

That is, in response to upgrade from the first-level store to the second-level store and existence of a difference between the second functional area combination corresponding to the second-level store and a third functional area combination corresponding to a third-level store, the second number of display positions on the first store interface may be unlocked, and display of the difference between the second functional area combination and the third functional area combination may be added, to obtain the second store interface of the second-level store, where the first store interface further may display a prompt for upgrading the store to unlock the difference between the second functional area combination and the third functional area combination. Alternatively, in response to upgrade from the first-level store to the second-level store and existence of a difference between the second functional area combination corresponding to the second-level store and a third functional area combination corresponding to a third-level store, the second store interface of the second-level store may be displayed, where the second store interface may display the third functional area combination, and the difference between the second functional area combination and the third functional area combination may be displayed in the locked state. The second store interface further may display a prompt for upgrading the store to unlock the difference.

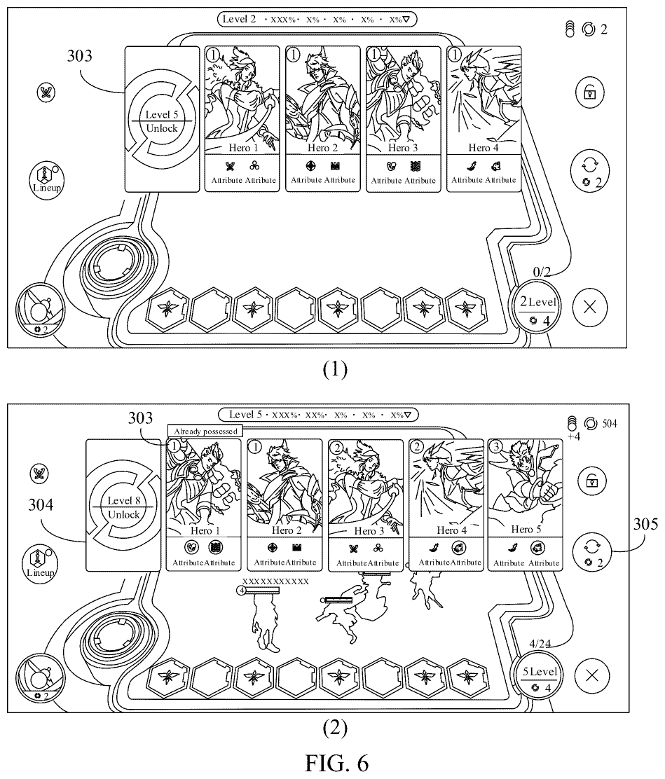

For example, (1) in FIG. 6 shows a first store interface, and the first store interface may display a second functional area combination of a second-level store (a store of a level 5). The second functional area combination may include 5 display positions, the first functional area combination may include 4 display positions, and the difference between the two functional area combinations may be a third display position 303. The first store interface may display the third display position 303 in the locked state, and the third display position may display a lock sign and prompt information “unlock level 5”, and may display no chess piece for sale. When the store is upgraded from a first-level store (a store of a level 4) to a second-level store (a store of a level 5), (2) in FIG. 6 shows a second store interface, and the second store interface may display a third functional area combination of a third-level store (a store of a level 6). The third functional area combination may include 6 display positions, the second functional area combination may include 5 display positions, and the difference between the two functional area combinations may be a fourth display position 304. Then, the third display position 303 may be displayed in the unlocked state in the second store interface, and the third display position in the unlocked state may display a chess piece for sale. The fourth display position 304 may be displayed in the locked state, the fourth display position may display a lock sign and prompt information “unlock level 6”, and the fourth display position may display no chess piece for sale. When the store level is upgraded, chess pieces displayed on the original display positions (the original 4 display positions in the figure, that is, the first number of display positions) may be refreshed accordingly.

Operation 230: Display a purchased first chess piece in a chess piece candidate area of the battle of the turn-based chess game in response to reception of an operation of purchasing the first chess piece on the second store interface.

Users may purchase chess pieces on the second store interface. When the store level is upgraded to the second level, along with the refresh of the store interface, chess pieces for sale in the store may be also refreshed. For example, chess pieces displayed in the second store interface may be refreshed according to a chess piece refresh probability of the second-level store.

The second store interface may include a first display position. The first display position may be one of the first number of display positions. The first display position may also be one of the second number of display positions. After the first-level store is upgraded to the second-level store, the chess piece on the first display position may be refreshed and displayed as the first chess piece. In response to reception of a purchase operation triggered on the first chess piece, the terminal device may display the first chess piece in the chess piece candidate area of the battle of the turn-based chess game, and the first display position may display no chess piece. In response to the operation of refreshing the store, the first display position may display chess pieces obtained after refresh. That is, after a user purchases a chess piece from a display position, the display position may be displayed as being empty, and the display position may display no chess piece until the next refresh of the store interface.

After the user account purchases the first chess piece on the first display position, the chess piece on the first display position may also be refreshed immediately. Then, after the purchase, the chess piece on the first display position may change from the first chess piece to the second chess piece. That is, after a user purchases a chess piece from a display position, the chess piece on the display position may be refreshed immediately.

A purchased chess piece (such as the first chess piece) may be first displayed in the chess piece candidate area. In response to a user movement operation, the chess piece in the chess piece candidate area may be moved to the battle area. Alternatively, the purchased chess piece may be displayed directly in the battle area. Optionally, if the purchased chess piece (such as the first chess piece) may trigger the fusion upgrade of an existing chess piece, the first chess piece just purchased may not be additionally displayed, and instead the first chess piece may be directly fused with the existing chess piece and the existing chess piece obtained after the upgrade may be displayed.

The store may be displayed as the functional area combination corresponding to the next-level store, the difference between the functional area combinations of the current-level store and the next-level store may be displayed in the locked state, and after the store is upgraded to the next level, the difference may be unlocked and displayed. The store level and some of benefits brought by change in the store level may be intuitively displayed through the display style of the store interface. Moreover, some of benefits that may be brought by the next-level store may be displayed in advance, which greatly improves the information transmission efficiency of the store interface to adapt to the fast battle of the turn-based chess game.

For example, stores of different levels may correspond to different chess piece refresh probabilities.

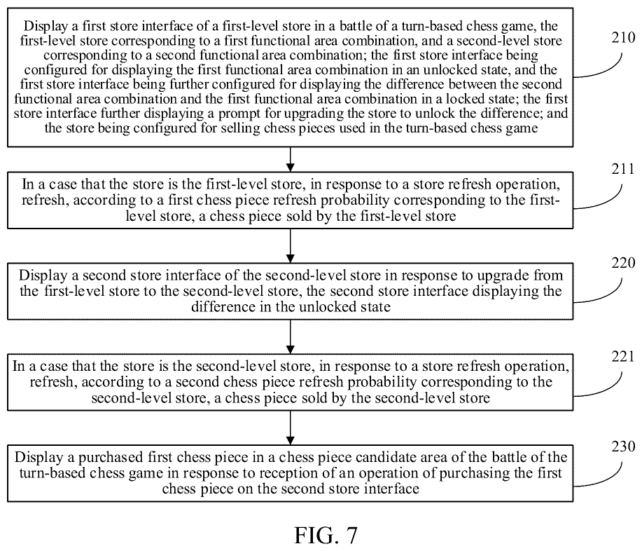

FIG. 7 is a flowchart of one or more aspects of a store upgrade method for a turn-based chess game. The method may be performed by any terminal in FIG. 2 or a client running on any terminal, and the client may be a client of a turn-based chess game. The method may include:

Operation 210: Display a first store interface of a first-level store in a battle of a turn-based chess game. The first-level store may correspond to a first functional area combination. The turn-based chess game with further include a second-level store corresponding to a second functional area combination. The first store interface may be configured for displaying the first functional area combination in an unlocked state, and displaying a difference between the second functional area combination and the first functional area combination in a locked state. The first store interface may further display a prompt for upgrading the store to unlock the difference. The store may be further configured for selling chess pieces used in the turn-based chess game.

In response to an operation of start of the preparation phase/end of the battle/opening the store, the first store interface of the first-level store may be displayed in the battle of the turn-based chess game. The first store interface may be displayed in the form of a pop-up window on the upper layer of the battle interface of the turn-based chess game. The store level may be displayed on the first store interface, or the store level may be displayed in the battle interface of the turn-based chess game. The battle interface of the turn-based chess game may include a store control, and the store control may be used to open the store. When there is a difference between the functional area combinations corresponding to the current-level store (the first-level store) and the next-level store (the second-level store), the store interface of the current-level store may be displayed as the functional area combination corresponding to the next-level store, the difference may be displayed in the locked state, and prompt information indicating that the difference is unlocked in the next-level store may be displayed. When the difference includes a UI control, the control in the locked state may not respond to a trigger operation.

Users may purchase chess pieces on the first store interface. The first product interface may include the first number of display positions and the second number of display positions in the locked state, and the user may purchase the chess pieces on the first number of display positions. A purchased third chess piece may be displayed in a chess piece candidate area of the turn-based chess game in response to reception of an operation of purchasing the third chess piece on the first store interface.

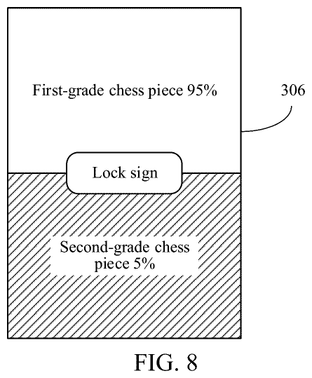

When the difference includes a display position, the second chess piece refresh probability corresponding to the second-level store may be displayed on the locked display position. For example, the appearance probability of each grade of chess piece based on the second chess piece refresh probability may be displayed on the display position. Alternatively, when the second-level store is refreshed to obtain a new chess piece compared to the first-level store, an icon or indication information of the new chess piece that may be obtained by refresh may be displayed on the locked display position. For example, FIG. 8 shows a display style of a display position 306 in the locked state. When an appearance probability of a first-grade chess piece in the first-level store is 100% and an appearance probability of a second-grade chess piece is 0%, and an appearance probability of the first-grade chess piece in the second-level store is 95% and an appearance probability of the second-grade chess piece is 5%, the second chess piece refresh probability corresponding to the second-level store may be displayed on the locked second number of display positions (the appearance probability of the first-grade chess piece may be 95%, and the appearance probability of the second-grade chess piece may be 5%), and a refresh probability corresponding to the second-grade chess piece that only appears in the second-level store may be highlighted. That is, in response to that the second-level store being refreshed to obtain a new type of chess piece compared to the first-level store, indication information of the new type of chess piece may be displayed on the locked display position, where the indication information may be used to prompt that the second-level store may be refreshed to obtain the new type of chess piece after unlocking. Alternatively, the second chess piece refresh probability of the second-level store may be displayed on the locked display position, and when the second chess piece refresh probability includes a chess piece that is not included in the first chess piece refresh probability, an appearance probability of the chess piece that is not included in the first chess piece refresh probability may be highlighted.

Operation 211: In a case that the store is the first-level store, in response to a store refresh operation, refresh, according to a first chess piece refresh probability corresponding to the first-level store, a chess piece sold by the first-level store.

The first store interface may display a store refresh control. For example, as shown in (1) in FIG. 5, the first store interface may include a store refresh control 305. In response to triggering the store refresh control on the first store interface, the chess piece for sale in the first-level store may be refreshed based on the first chess piece refresh probability corresponding to the first-level store.

The chess piece refresh probability (including the first chess piece refresh probability and the second chess piece refresh probability) may include an appearance probability corresponding to each chess piece in a chess piece library, or the chess piece refresh probability may include an appearance probability corresponding to each type of chess piece (the type may be based on any dimension) in a chess piece library, or the chess piece refresh probability may include an appearance probability corresponding to each grade of chess piece in a chess piece library. The chess piece library may include all chess pieces that may appear in the store.

As shown in Table 2, the chess piece refresh probability may include the appearance probability corresponding to each grade of chess piece.

TABLE 2

| | Proba- | Proba- | Proba- | Proba- | Proba- |
|---|---|---|---|---|---|
| | bility | bility | bility | bility | bility |
| | of chess | of chess | of chess | of chess | of chess |
| Store | piece of | piece of | piece of | piece of | piece of |
| level | grade 1 | grade 2 | grade 3 | grade 4 | grade 5 |
| 2 | 100% | | | | |
| 3 | 95% | 5% | | | |
| 4 | 79% | 20% | 1% | | |
| 5 | 45% | 50% | 5% | | |
| 6 | 20% | 35% | 40% | 5% | |
| 7 | 14% | 30% | 30% | 25% | 1% |
| 8 | 7% | 20% | 30% | 25% | 18% |

When the store level in the game is a level 2, only a chess piece of a grade 1 may be refreshed. When the store level in the game is a level 3, there is a 95% probability of refreshing to obtain a chess piece with a grade 1, and a 5% probability of refreshing to obtain a chess piece with a grade 2. When the store level in the game is a level 4, there is a 79% probability of refreshing to obtain a chess piece with a grade 1, a 20% probability of refreshing to obtain a chess piece with a grade 2, and a 1% probability of refreshing to obtain a chess piece with a grade 3. When the store level in the game is a level 5, there is a 45% probability of refreshing to obtain a chess piece with a grade 1, a 50% probability of refreshing to obtain a chess piece with a grade 2, and a 5% probability of refreshing to obtain a chess piece with a grade 3. When the store level in the game is a level 6, there is a 20% probability of refreshing to obtain a chess piece with a grade 1, a 35% probability of refreshing to obtain a chess piece with a grade 2, a 40% probability of refreshing to obtain a chess piece with a grade 3, and a 5% probability of refreshing to obtain a chess piece with a grade 4. When the store level in the game is a level 7, there is a 14% probability of refreshing to obtain a chess piece with a grade 1, a 30% probability of refreshing to obtain a chess piece with a grade 2, a 30% probability of refreshing to obtain a chess piece with a grade 3, a 25% probability of refreshing to obtain a chess piece with a grade 4, and a 1% probability of refreshing to obtain a chess piece with a grade 5. When the store level in the game is a level 8, there is a 7% probability of refreshing to obtain a chess piece with a grade 1, a 20% probability of refreshing to obtain a chess piece with a grade 2, a 30% probability of refreshing to obtain a chess piece with a grade 3, a 25% probability of refreshing to obtain a chess piece with a grade 4, and an 18% probability of refreshing to obtain a chess piece with a grade 5.

For example, when a probability of a chess piece in Table 2 is empty, it may be used to indicate that a refresh probability of the chess piece is 0%. For example, when the store level in the game is a level 2, refresh probabilities of chess pieces of a grade 2 to a grade 5 are all 0%. Therefore, referring to Table 2, when the store level is upgraded to a level 5 and a fifth new display position is unlocked, a probability of a grade of chess piece obtained in this display position by refresh may be a probability of a chess piece of a grade 1/2/3/4/5 corresponding to a store level 5. When the store level is upgraded to a level 8 and a sixth new display position is unlocked, a probability of a grade of chess piece obtained in this display position by refresh may be a probability of a chess piece of a grade 1/2/3/4/5 corresponding to a store level 8.

Referring to Table 1, when the store level is the level 2 (the first-level store), after refreshing the store, an appearance probability of a chess piece obtained by refresh in the 4 display positions may be a probability of a chess piece of a grade 1/2/3/4/5 corresponding to the store level 2.

Operation 220: Display a second store interface of the second-level store in response to upgrade from the first-level store to the second-level store, the second store interface displaying the difference in the unlocked state.

In response to the store experience point of the first-level store meeting a condition for upgrade to the second-level store, the store level may be upgraded from the first level to the second level, and the first store interface may be refreshed to display the second store interface.

In response to an operation of purchasing a store experience point, the gold coins of the user account may be reduced and the corresponding store experience points may be increased. In response to the store experience point meeting a condition for upgrade to the second level, the store level may be upgraded from the first level to the second level, and the first store interface may be refreshed to display the second store interface. In response to an operation of upgrading the store level, the gold coins of the user may be are reduced, the store level may be upgraded from the first level to the second level, and the first store interface may be refreshed to display the second store interface.

A transition animation of transition from the first store interface to the second store interface may be displayed. Alternatively, an unlock animation of the difference in the locked state on the first store interface may be displayed to obtain the second store interface. If the store interface is not opened when the store level is upgraded, the second store interface may be displayed directly when the store interface is opened.

If the difference includes a UI control, the UI control in the unlocked state may be allowed to respond to a user trigger operation.

The chess pieces for sale in the second store interface may be obtained by refresh based on the second chess piece refresh probability corresponding to the second-level store.

Operation 221: In a case that the store is the second-level store, in response to a store refresh operation, refresh, according to a second chess piece refresh probability corresponding to the second-level store, a chess piece sold by the second-level store.

The second store interface may display a store refresh control. For example, as shown in (2) in FIG. 5, the second store interface may include a store refresh control 305. In response to triggering the store refresh control in the second store interface, the chess piece for sale in the second-level store may be refreshed based on the second chess piece refresh probability corresponding to the second-level store.

For example, as shown in Table 2, the chess piece for sale in the second store interface may be refreshed according to the appearance probability of each grade of chess piece corresponding to the second-level store.

When the store level of the second-level store is higher than that of the first-level store, an appearance probability of a first-grade chess piece based on the first chess piece refresh probability may be lower than an appearance probability of the first-grade chess piece based on the second chess piece refresh probability; and an appearance probability of a second-grade chess piece based on the first chess piece refresh probability may be higher than an appearance probability of the second-grade chess piece based on the second chess piece refresh probability. For example, at least one of a virtual attack power, a virtual life value, and a virtual defense value of the second-grade chess piece may be better than that of the first-grade chess piece. That is, a higher store level may indicate a higher appearance probability of a high-grade chess piece, and a lower appearance probability of a low-grade chess piece.

Operation 230: Display a purchased first chess piece in a chess piece candidate area of the battle of the turn-based chess game in response to reception of an operation of purchasing the first chess piece on the second store interface.

Operation 230 may be performed before or after operation 221. That is, a chess piece may be purchased on the second store interface before or after the second store interface is refreshed.

The chess piece refresh probability of the store may be increased after the store level is upgraded, making it easier for a high-quality chess piece to appear in a high-level store. Based on this, when the first store interface is displayed, the chess piece refresh probability of the second-level store may be displayed on the locked display position to inform a user that a probability of obtaining a higher-grade chess piece increases after the store level is upgraded.

In the process of gradually upgrading the first-level store to the second-level store, the locked difference may be displayed according to the upgrade progress of the store level, to prompt a user that the store level is to be upgraded and the difference is to be unlocked.

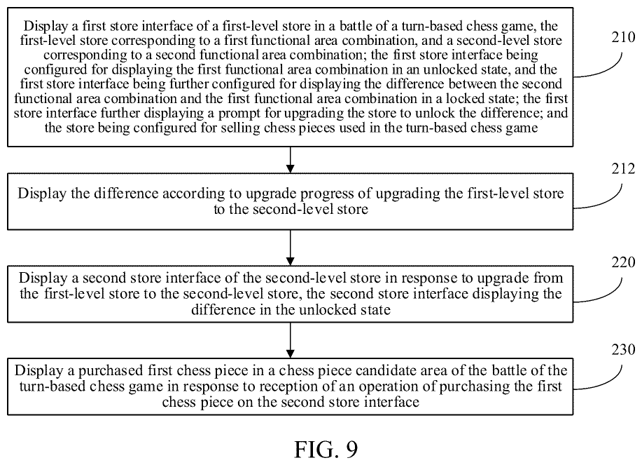

FIG. 9 is a flowchart of one or more aspects of a store upgrade method for a turn-based chess game. The method may be performed by any terminal in FIG. 2 or a client running on any terminal, and the client may be a client of a turn-based chess game. The method may include:

Operation 210: Display a first store interface of a first-level store in a battle of a turn-based chess game. the first-level store corresponding to a first functional area combination, and a second-level store corresponding to a second functional area combination. The first store interface may be configured for displaying the first functional area combination in an unlocked state, a difference between the second functional area combination and the first functional area combination in a locked state, and a prompt for upgrading the store to unlock the difference. The store may be configured for selling chess pieces used in the turn-based chess game

Operation 212: Display the difference according to upgrade progress of upgrading the first-level store to the second-level store.

For example, as the store experience point in the first-level store increases, the difference may be also unlocked. Therefore, during the increase of the store experience point, the display of the difference may be changed accordingly.

Three examples for the difference to change with the level upgrade progress are provided:

(1) In a case that upgrade progress of upgrading the first-level store to the second-level store reaches a first threshold, the difference may be highlighted. The first threshold may be set in any manner. For example, the first threshold may be set to 90%, or if the store experience point required to upgrade to the second-level store is 200, the first threshold may be that the experience point reaches 180.

Highlight may include: high brightness display, lock sign shaking, lock sign blur, and the like.

(2) Display an unlock progress bar in the difference according to upgrade progress of upgrading the first-level store to the second-level store.

The unlock progress bar may also be displayed in the difference, and the unlock progress bar may advance with the upgrade progress of the store level.

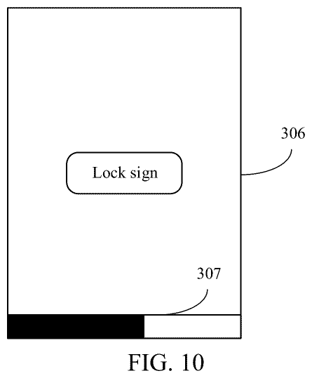

For example, when the difference includes a display position, as shown in FIG. 10, an unlock progress bar 307 may be displayed on a locked display position 306. The unlock progress in the unlock progress bar may be synchronized with the upgrade progress of the store level. When the store is upgraded to the second-level store, the unlock progress bar may be full and an unlock animation may be played to unlock the display position.

(3) The displaying a second number of display positions in a locked state may include: add opaque masks to the second number of display positions respectively to hide chess pieces displayed in the second number of display positions, where a display position in the locked state does not respond to a purchase operation; in a case that upgrade progress of upgrading from the first-level store to the second-level store exceeds a second threshold, control opaqueness of the opaque mask to decrease with the increase of the upgrade progress, to gradually display the chess pieces in the second number of display positions; and
when the store level is upgraded to the second level: in response to that the upgrade progress reaches the second-level store, cancel display of the opaque mask and displaying chess pieces in the second number of display positions, to obtain the second store interface of the second-level store.

For example, the two operations in (3) may be combined with operation 210 and operation 230 to form an additional aspect that may be implemented independently. This is not limited. That is, when the upgrade progress of the store level is below the second threshold, the locked display position may be completely opaque and no chess piece for sale may be displayed. When the upgrade progress of the store level reaches the second threshold, or is higher than the second threshold, the mask on the locked display position may begin to gradually change from being completely opaque to being gradually transparent, and a chess piece may be obtained by refresh and displayed on the locked display position based on the second chess piece refresh probability of the second-level store. As the upgrade progress increases, the chess piece displayed on the locked display position may gradually become clearer until the chess piece is clearly displayed on this display position and the display position may be unlocked when the store level is upgraded to the second level.

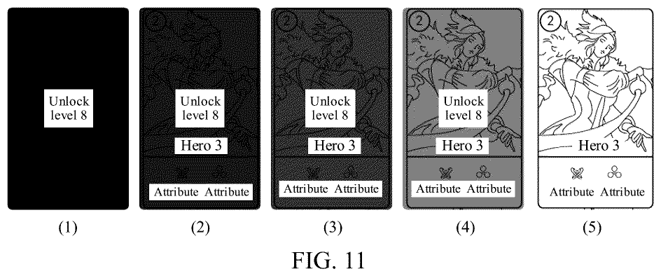

FIG. 11 is a schematic diagram of one or more aspects of a display position of a store upgrade method for a turn-based chess game. For example, as shown in (1) in FIG. 11, when the upgrade progress of upgrading the first-level store to the second-level store is lower than the second threshold, the display position may be covered with an opaque mask and a user may not see a chess piece for sale on the display position. When the upgrade progress of upgrading the first-level store to the second-level store reaches the second threshold, as shown in (2), (3), and (4) in FIG. 11, the opaque mask on the display position may begin to gradually become transparent as the upgrade progress of the store level is upgraded. When the first-level store is upgraded to the second-level store, as shown in (5) in FIG. 11, the display of the opaque mask on the display position may be canceled (or the transparency of the opaque mask may be set to be fully transparent), and the display of the unlock prompt information on the display position may be canceled. In this case, the display position may be displayed in the unlocked state, and a user may clearly see the chess pieces for sale on the display position and may purchase the chess piece.

In the process in which the mask on the display position gradually becomes transparent, if the store is refreshed, the chess piece displayed on the display position may also be refreshed. A difference is that chess pieces on other unlocked display positions may be refreshed based on the first chess piece refresh probability of the first-level store, and the chess piece on the locked display position may be refreshed based on the second chess piece refresh probability of the second-level store. That is, in a case that the store is the first-level store, in response to a store refresh operation, chess pieces displayed in the first number of display positions may be refreshed based on the first chess piece refresh probability corresponding to the first-level store, and chess pieces displayed in the second number of display positions may be refreshed based on the second chess piece refresh probability corresponding to the second-level store.

When the store is upgraded to the second-level store, the second number of display positions may be unlocked, and the chess pieces in the first number of display positions and the second number of display positions may be all refreshed based on the second chess piece refresh probability. Since the second number of display positions originally display chess pieces obtained by refresh based on the second chess piece refresh probability in the method (3), the chess pieces on the second number of display positions may be controlled to remain unchanged when the store level is upgraded, and only the chess pieces on the first number of display positions may be refreshed.

Operation 220: Display a second store interface of the second-level store in response to upgrade from the first-level store to the second-level store, the second store interface displaying the difference in the unlocked state.

Operation 230: Display a purchased first chess piece in a chess piece candidate area of the battle of the turn-based chess game in response to reception of an operation of purchasing the first chess piece on the second store interface.

The difference may be controlled to be displayed with the upgrade progress of the store level, so as to prompt the user that the difference is to be unlocked with upgrade of the store level. When the difference includes a display position, after the upgrade progress reaches a threshold, the chess piece may be obtained by refresh and displayed on the display position in advance, and the chess piece may be hidden. As the upgrade progress increases, hiding of the chess piece may be gradually canceled, so that the user may know, in advance, the chess piece that may be obtained by unlocking the display position, to allow users to make corresponding decisions in advance based on the new chess piece that may be obtained by store upgrade, improving information transmission efficiency on the store interface.

The display position in the high-level store may be used not only to sell a chess piece, but also sell a store exchange card. Using the store exchange card allows two sides of a battle to exchange stores, and a user may buy chess pieces in the enemy store. If the enemy store is of a higher level, the user may purchase a high-grade chess piece.

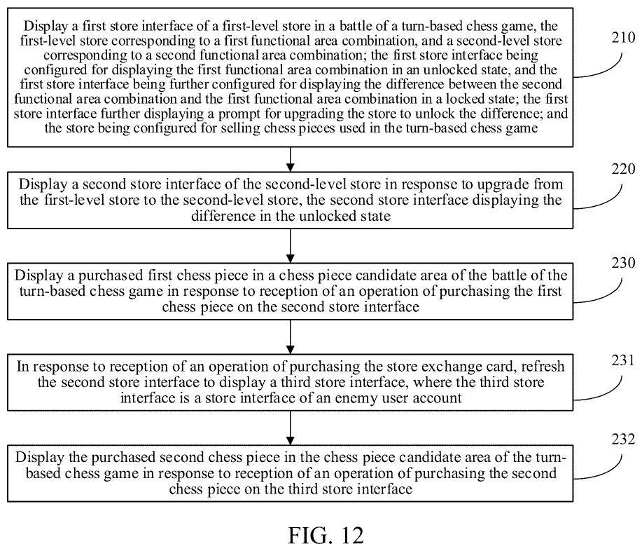

FIG. 12 is a flowchart of one or more aspects of a store upgrade method for a turn-based chess game. The method may be performed by any terminal in FIG. 2 or a client running on any terminal, and the client may be a client of a turn-based chess game. The method may include:

Operation 210: Display a first store interface of a first-level store in a battle of a turn-based chess game. The first-level store may correspond to a first functional area combination, and a second-level store may correspond to a second functional area combination. The first store interface being configured for displaying the first functional area combination in an unlocked state, a difference between the second functional area combination and the first functional area combination in a locked state, and a prompt for upgrading the store to unlock the difference. The store may be configured for selling chess pieces used in the turn-based chess game;

Operation 220: Display a second store interface of the second-level store in response to upgrade from the first-level store to the second-level store, the second store interface displaying the difference in the unlocked state.

Operation 230: Display a purchased first chess piece in a chess piece candidate area of the battle of the turn-based chess game in response to reception of an operation of purchasing the first chess piece on the second store interface.

An execution order of operation 230 and operation 231 is not limited.

Operation 231: Refresh, in response to reception of an operation of purchasing the store exchange card, the second store interface to display a third store interface, where the third store interface is a store interface of an enemy user account.

The display position unlocked in the second-level store may also be used to sell a store exchange card. That is, at least one of the second number of display positions unlocked in the second-level store may be configured for selling a store exchange card. For example, a fourth display position may be unlocked in the second-level store, and the fourth display position may be refreshed to obtain a store exchange card. In response to reception of an operation of purchasing a store exchange card triggered on the fourth display position, the store exchange card may be purchased and used to exchange a self store with an enemy store. A store interface (the second store interface) of the self store may be refreshed to display a store interface (the third store interface) of the enemy store. The store level of the self store and the store level of the enemy store are not limited. The store level of the enemy store may be higher than the store level of the self store, and the store level of the enemy store may also be lower than the store level of the self store.

When the store level of the enemy store is higher than the store level of the self store, the fourth display position may be refreshed to obtain a store exchange card. When the store level of the enemy store is equal to or lower than the store level of the self store, a probability that the fourth display position is refreshed to obtain a store exchange card may be 0%.

For example, a client may send a store exchange request to a server in response to reception of the operation of purchasing the store exchange card, where the store exchange request may be configured for requesting exchange of stores of two parties of the battle; the client may receive a store exchange instruction sent by the server, where the store exchange instruction may include the third store interface of the enemy user account; and the client may refresh the second store interface to display the third store interface according to the store exchange instruction.

Operation 232: Display the purchased second chess piece in the chess piece candidate area of the turn-based chess game in response to reception of an operation of purchasing the second chess piece on the third store interface.

Users may purchase chess pieces on the third store interface. Users may refresh the third store interface. When refreshing the third store interface, chess pieces for sale on the interface may be refreshed according to the chess piece refresh probability corresponding to the store level of the enemy store.

A user may purchase a third number of chess pieces on the third store interface (including chess pieces purchased on the third store interface after refreshing the third store interface). The third number may be set in any manner. For example, the third number may be 3. In response to that the number of chess pieces purchased by the user on the third store interface reaches a third number, the store exchange may be ended and the second store interface may be re-displayed. Alternatively, the third store interface has an exchange time, and in response to the end of the exchange time, the store exchange may be ended and the second store interface may be re-displayed. Alternatively, in response to that an enemy user account purchases and uses the store exchange card, the store exchange may be ended and the second store interface may be re-displayed.

Commodities for sale on the display positions may be increased after the store level is upgraded, so that the store is not limited to sell a chess piece, but may also be used to sell the store exchange card. The user account purchases and uses the store exchange card to exchange the store with the enemy, and then purchases chess pieces in the enemy store.

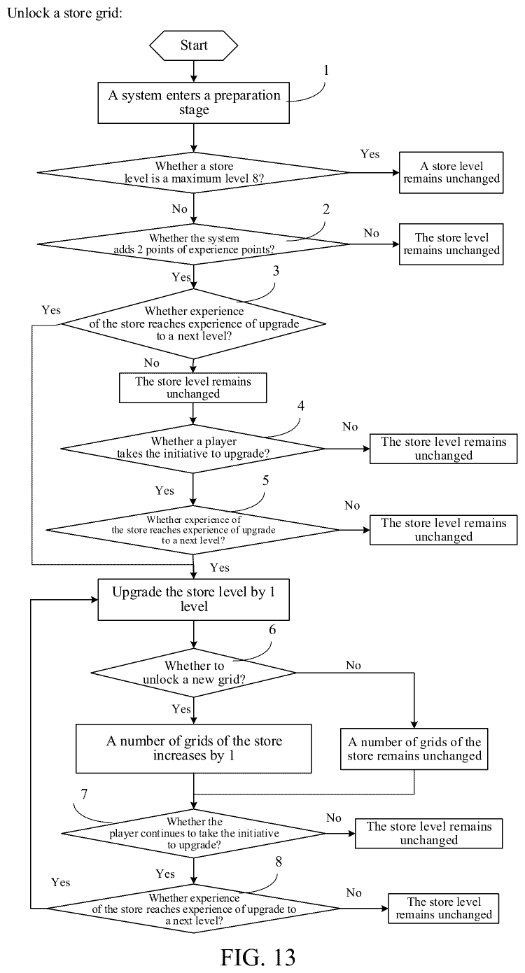

FIG. 13 is a flowchart of one or more aspects of a store upgrade method for a turn-based chess game. The method may be performed by any terminal in FIG. 2 or a client running on any terminal, and the client may be a client of a turn-based chess game (. The method may include:
Operation 1: Enter a preparation stage. In this case, priority may be given to determine whether a store level is a maximum level, that is, a level 8, and if the store level is the maximum level, the store level remains unchanged, or if the store level is the maximum level, proceed to operation 2 for determining.
Operation 2: Determine whether a system adds 2 points of experience, and if the system does not add 2 points of experience, the store level remains unchanged, or if the system adds 2 points of experience, proceed to operation 3 for determining. The system automatically adds 2 store experience points to a user account after a turn is ended.
Operation 3: Determine whether the store level reaches experience of upgrade to a next level, and if “yes”, upgrade the store level by 1 level and proceed to operation 6, or if “no”, the store level remains unchanged, and proceed to operation 4 for determining.
Operation 4: Determine whether the user account takes the initiative to upgrade the level, and if “no”, the store level remains unchanged, or if “yes”, proceed to operation 5 for determining. User accounts may use gold coins to purchase store experience points, or use gold coins to upgrade the store level.
Operation 5: Determine whether the store experience reaches experience of upgrade to a next level, and if “no”, the store level remains unchanged, or if “yes”, upgrade the store level by 1 level and proceed to operation 6 for determining.
Operation 6: Determine whether to unlock a new store grid (a display position), and if “no”, a number of store grids remains unchanged and proceed to operation 7 for determining, or if “yes”, increase the number of store grids by 1 and proceed to operation 7 for determining.
Operation 7: Determine whether the user account continues to take the initiative to upgrade the level, and if “no”, the store level remains unchanged, or if “yes”, proceed to operation 8 for determining.

Operation 8: Determine whether the store experience reaches experience of a next level, and if “no”, the store level remains unchanged, or if “yes”, upgrade the store level by 1 level and proceed to operation 6 for determining.

Based on the mechanism of the traditional turn-based chess game, during upgrade of some key levels, an additional grid (a display position) may be permanently added to the store to refresh to obtain a hero. In this way, novice players may more clearly perceive the effects of upgrading the store, thereby guiding players to save money to upgrade the store level. Moreover, this may reduce the number of grids in the store in the early stage of the game (3), reduce the decision-making pressure of players in the early stage, and guide players to focus on economic operations, thereby upgrading the store level. In the later stage of the game, due to the fast pace of a mobile game, a high-level store has more grids (6 grids). This improves player income of refreshing the store in the later stage to some extent, to find desired high-quality chess pieces with fewer refreshes. This also helps improve the rhythm of the game and compress the duration of a single game, and reduces the server load.

The following discussion relates to a turn-chess apparatus and for details not described in the apparatus discussion, reference may be made to the method discussion above.

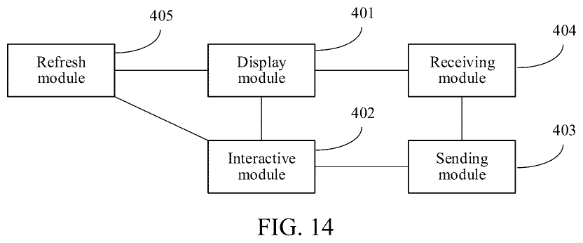

FIG. 14 is a block diagram of one or more aspects of a store upgrade apparatus for a turn-based chess game. The apparatus may include:
a display module 401, configured to perform operation 210 discussed in reference to in FIG. 3;
the display module 401 being configured to perform operation 220 discussed in reference to FIG. 3; and an interactive module 402, configured to receive an operation of purchasing a first chess piece;
the display module 401 being configured to perform operation 230 discussed in reference to FIG. 3. The first functional area combination may include a first number of display positions, the second functional area combination may include the first number of display positions and a second number of display positions, and the difference may include the second number of display positions; and
the display module 401 being configured to unlock the second number of display positions on the first store interface in response to upgrade from the first-level store to the second-level store, to obtain the second store interface of the second-level store.

The display module 401 may be configured to: in response to upgrade from the first-level store to the second-level store and existence of a difference between the second functional area combination corresponding to the second-level store and a third functional area combination corresponding to a third-level store, unlock the second number of display positions on the first store interface, and add display of the difference between the second functional area combination and the third functional area combination, to obtain the second store interface of the second-level store, where the first store interface further displays a prompt for upgrading the store to unlock the difference between the second functional area combination and the third functional area combination.

The display module 401 may be configured to: when the store is upgraded from the first-level store to the second-level store, refresh the first store interface and display the second store interface corresponding to the second-level store.

The apparatus further may include: a refresh module 405, configured to perform operation 211 discussed in reference to FIG. 7; and configured to perform operation 221 discussed in reference to FIG. 7; an appearance probability of a first-grade chess piece based on the first chess piece refresh probability is lower than an appearance probability of the first-grade chess piece based on the second chess piece refresh probability; and an appearance probability of a second-grade chess piece based on the first chess piece refresh probability is higher than an appearance probability of the second-grade chess piece based on the second chess piece refresh probability, and the first-grade chess piece is better than the second-grade chess piece.

The display module 401 may be configured to: in a case that upgrade progress of upgrading the first-level store to the second-level store reaches a first threshold, highlight the difference; or display an unlock progress bar in the difference according to upgrade progress of upgrading the first-level store to the second-level store.

The displaying a second number of display positions in a locked state may include: adding opaque masks to the second number of display positions respectively to hide chess pieces displayed in the second number of display positions, where a display position in the locked state does not respond to a purchase operation; and
the display module 401 is configured to: in a case that upgrade progress of upgrading from the first-level store to the second-level store exceeds a second threshold, control opaqueness of the opaque mask to decrease with the increase of the upgrade progress, to gradually display the chess pieces in the second number of display positions; and
the display module 401 is configured to: in response to that the upgrade progress reaches the second-level store, cancel display of the opaque mask and display chess pieces in the second number of display positions, to obtain the second store interface of the second-level store.

The apparatus further may include:
a refresh module 405, configured to: in a case that the store is the first-level store, in response to a store refresh operation, refresh, according to a first chess piece refresh probability corresponding to the first-level store, chess pieces displayed in the first number of display positions, and refresh, according to a second chess piece refresh probability corresponding to the second-level store, chess pieces displayed in the second number of display positions.

At least one of the second number of display positions may be configured for selling a store exchange card; and
the display module 401 being configured to perform operation 231 discussed in reference to FIG. 7; and
the display module 401 being configured to perform operation 232 discussed in reference to FIG. 7.

The apparatus further may include:
a sending module 403, configured to transmit a store exchange request to a server in response to reception of the operation of purchasing the store exchange card, where the store exchange request is configured for requesting exchange of stores of two parties of the battle; and
a receiving module 404, configured to receive a store exchange instruction sent by the server, where the store exchange instruction may include the third store interface of the enemy user account; and
the display module 401 being configured to refresh the second store interface to display the third store interface according to the store exchange instruction.

The above functional modules may be allocated to different functional modules according to specific needs, which means that the internal structure of the apparatus may be divided to different functional modules to complete all or some of the above described functions. In addition, any details not included in the store upgrade apparatus discussion may be retrieved from the turn-based chess game method discussed above.

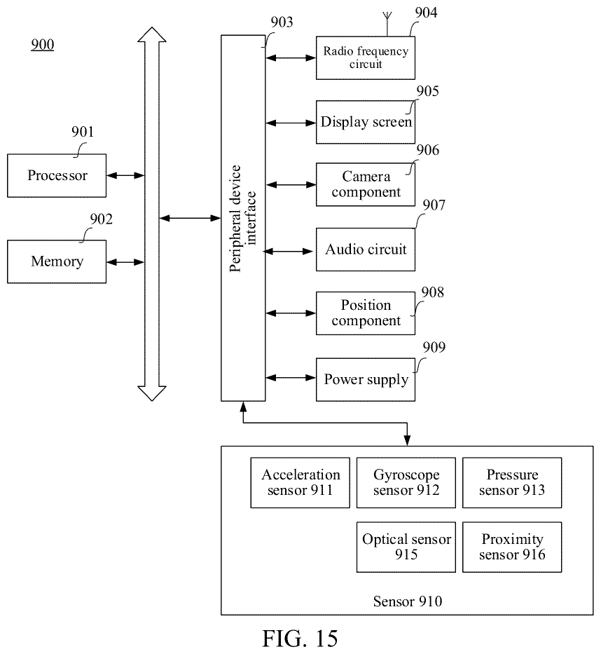

A terminal is also provided, the terminal including a processor and a memory, the memory storing at least one instruction, and the at least one instruction being loaded and executed by the processor to implement the methods discussed above. The terminal may be a terminal shown in FIG. 15.

FIG. 15 is a structural block diagram of a terminal 900 for a turn-based chess game. The terminal 900 may be: a smartphone, a tablet computer, a moving picture experts group audio layer III (MP3) player, or a moving picture experts group audio layer IV (MP4) player, a laptop computer, or a desktop computer. The terminal 900 may also be referred to as another name such as user equipment, a portable terminal, a laptop terminal, or a desktop terminal.

The terminal 900 generally may include: a processor 901 and a memory 902.

The processor 901 may include one or more processing cores, for example, a 4-core processor or an 8-core processor. The processor 901 may be implemented in at least one hardware form of a digital signal processor (DSP), a field-programmable gate array (FPGA), and a programmable logic array (PLA). The processor 901 may also include a main processor and a co-processor. The main processor may be a processor configured to process data in an awake state, and is also referred to as a central processing unit (CPU). The co-processor may be a low power consumption processor configured to process data in a standby state. The processor 901 may be integrated with a graphics processing unit (GPU). The GPU may be configured to render and draw content that needs to be displayed on a display screen. The processor 901 may further include an artificial intelligence (AI) processor. The AI processor may be configured to process computing operations related to machine learning.

The memory 902 may include one or more computer-readable storage mediums. The computer-readable storage medium may be non-transitory. The memory 902 may further include a high-speed random access memory and a nonvolatile memory, for example, one or more disk storage devices or flash storage devices. The non-transitory computer-readable storage medium in the memory 902 may be configured to store at least one instruction, and the at least one instruction may be configured to be executed by the processor 901 to implement the methods discussed above.

The terminal 900 further may include: a peripheral device interface 903 and at least one peripheral device. The processor 901, the memory 902, and the peripheral device interface 903 may be connected through a bus or a signal cable. Each peripheral device may be connected to the peripheral device interface 903 through a bus, a signal cable, or a circuit board. Specifically, the peripheral device may include: at least one of a radio frequency (RF) circuit 904, a display screen 905, a camera component 906, an audio circuit 907, a position component 908, and a power supply 909. The peripheral device interface 903 may be configured to connect the at least one peripheral device related to input/output (I/O) to the processor 901 and the memory 902. The processor 901, the memory 902, and the peripheral device interface 903 may be integrated on the same chip or circuit board. Alternatively, any one or two of the processor 901, the memory 902, and the peripheral device interface 903 may be implemented on a single chip or circuit board. This is not limited. The radio frequency circuit 904 may be configured to receive and transmit a radio frequency signal, also referred to as an electromagnetic signal. The radio frequency circuit 904 may communicate with a communication network and other communication devices through the electromagnetic signal. The radio frequency circuit 904 may further include a circuit related to near field communication (NFC). The display screen 905 may be configured to display a user interface (UI). The UI may include a graph, a text, an icon, a video, and any combination thereof. The camera component 906 may be configured to capture images or videos. The camera component 906 may include a front-facing camera and a rear-facing camera. The audio circuit 907 may include a microphone and a speaker. The microphone may be configured to acquire sound waves of a user and an environment, and convert the sound waves into an electrical signal to input to the processor 901 for processing, or input to the radio frequency circuit 904 for implementing voice communication. The position component 908 may be configured to determine a current geographic location of the terminal 900, to implement a navigation or a location based service (LBS). The position component 908 may be a position component based on Global Positioning System (GPS) the BeiDou system, or the Galileo system. The power supply 909 may be configured to supply power to components in the terminal 900. The power supply 909 may be an alternating current, a direct current, a primary battery, or a rechargeable battery.

The terminal 900 further may include one or more sensors 910. The one or more sensors 910 may include, but are not limited to: an acceleration sensor 911, a gyroscope sensor 912, a pressure sensor 913, an optical sensor 915, and a proximity sensor 916. The acceleration sensor 911 may detect a magnitude of acceleration on three coordinate axes of a coordinate system established with the terminal 900. The gyroscope sensor 912 may detect a body direction and a rotation angle of the terminal 900, and may work with the acceleration sensor 911 to acquire a 3D action performed by the user on the terminal 900. The pressure sensor 913 may be disposed at a side frame of the terminal 900 and/or a lower layer of the display screen 905. The pressure sensor may detect a signal of holding the terminal 900 by a user, and/or may control an operable control on the UI according to a pressure operation of a user on the display screen 905. The optical sensor 915 may be configured to acquire ambient light intensity. The proximity sensor 916, also referred to as a distance sensor, may be generally disposed on the front panel of the terminal 900. The proximity sensor 916 may be configured to acquire a distance between the user and the front surface of the terminal 900.

A person skilled in the art may understand that the structure shown in FIG. 15 constitutes no limitation on the terminal 900, and the terminal may include more or fewer components than those shown in the figure, or some components may be combined, or a different component deployment may be used. The memory further may include one or more programs. The one or more programs may be stored in the memory. The one or more programs may include a program for performing the methods discussed above.

A non-transitory computer-readable storage medium is also provided. The non-transitory storage medium stores at least one instruction, and at least one instruction is loaded and executed by a processor, to implement the methods discussed above.

A computer program product or a computer program, including a computer instruction stored in a computer-readable storage medium is also provided. A processor of a computer device reads the computer instruction from the computer-readable storage medium, and the processor executes the computer instruction, so that the computer device performs the methods discussed above.

The sequence numbers of the one or more aspects described herein are merely for description purpose but do not imply the preferences.

A person of ordinary skill in the art may understand that all or some of the operations discussed herein may be implemented by hardware, or may be implemented by a program instructing relevant hardware. The program may be stored in a computer-readable storage medium. The storage medium may be a read-only memory, a magnetic disk, an optical disc, or the like.

A prompt interface or a pop-up window may be displayed, or voice prompt information may be outputted before collecting user-related data and when collecting user-related data. The prompt interface, the pop-up window, or the voice prompt information may be configured for prompting the user that user-related data is currently being collected. In this way, related operations of obtaining the user-related data only start to be executed after obtaining a confirmation operation of the user on the prompt interface or the pop-up window. Otherwise (that is, the confirmation operation of the user on the prompt interface or the pop-up window is not obtained), the related operations of obtaining the user-related data are ended, that is, the user-related data is not obtained. In other words, all user data collected is collected with the consent and authorization of the user, and the collection, usage, and processing of user-related data need to comply with the relevant laws, regulations, and standards of relevant countries and regions.

What is claimed is:

1. A computer-assisted method comprising:
generating, for a battle of a turn-based chess game comprising a first-level store selling chess pieces used in the turn-based chess game and a second-level store selling chess pieces used in the turn-based chess game, a first store interface of the first-level store, wherein the first-level store corresponds to a first functional area combination and the second-level store corresponds to a second functional area combination, and wherein the first store interface displays the first functional area combination in an unlocked state, a difference between the second functional area combination and the first functional area combination in a locked state, and a prompt for upgrading the first-level store to unlock the difference;
causing the first store interface to be output for display;
generating a second store interface of the second-level store in response to receiving one or more user inputs resulting in an upgrade from the first-level store to the second-level store, the second store interface displaying the difference in the unlocked state;
causing the second store interface to be output for display;
receiving, via the second store interface, an operation to purchase a first chess piece; and
causing to be output, for display and based on the receiving, the first chess piece in a chess piece candidate area of the battle of the turn-based chess game.

2. The computer-assisted method according to claim 1, wherein:
the first functional area combination comprises a first number of display positions,
the second functional area combination comprises the first number of display positions and a second number of display positions,
the difference comprises the second number of display positions, and
the generating the second store interface comprises unlocking the second number of display positions on the first store interface to generate the second store interface of the second-level store.

3. The computer-assisted method according to claim 2, wherein the unlocking comprises:
based on a difference between the second functional area combination corresponding to the second-level store and a third functional area combination corresponding to a third-level store, unlocking the second number of display positions on the first store interface, and adding display of the difference between the second functional area combination and the third functional area combination, wherein the first store interface further displays a prompt for upgrading the first-level store to unlock the difference between the second functional area combination and the third functional area combination.

4. The computer-assisted method according to claim 1, wherein the method further comprises:
based on the upgrade, causing to be output for display a refreshed first store interface.

5. The computer-assisted method according to claim 4, wherein the method further comprises:
generating the refreshed first store interface by refreshing, according to a first chess piece refresh probability corresponding to the first-level store, a chess piece sold by the first-level store; and
generating a refreshed second store interface by refreshing, according to a second chess piece refresh probability corresponding to the second-level store, a chess piece sold by the second-level store,
wherein an appearance probability of a first-grade chess piece based on the first chess piece refresh probability is lower than an appearance probability of the first-grade chess piece based on the second chess piece refresh probability, and
wherein an appearance probability of a second-grade chess piece based on the first chess piece refresh probability is higher than an appearance probability of the second-grade chess piece based on the second chess piece refresh probability.

6. The computer-assisted method according to claim 1, wherein before the causing to be output for display the second store interface, the method further comprises:
highlighting the difference based on a determination that an upgrade progress of the upgrading reaches a first threshold;
or
causing to be output for display an unlock progress bar in the difference indicating an upgrade progress of the upgrading.

7. The computer-assisted method according to claim 2, wherein:
the displaying a second number of display positions in a locked state comprises adding opaque masks to the second number of display positions to hide chess pieces displayed in the second number of display positions, and
the causing the second store interface to be output for display comprises:
based on a determination that an upgrade progress of upgrading from the first-level store to the second-level store exceeds a second threshold, gradually modifying display of chess pieces in the second number of display positions by controlling opaqueness of the opaque masks to decrease with an increase of the upgrade progress; and
based on a determination that the upgrade progress is complete, displaying chess pieces in the second number of display positions without the opaque masks.

8. The computer-assisted method according to claim 7, wherein the method further comprises:
in response to a store refresh operation, refreshing, according to a first chess piece refresh probability corresponding to the first-level store, chess pieces displayed in the first number of display positions; and
refreshing, according to a second chess piece refresh probability corresponding to the second-level store, chess pieces displayed in the second number of display positions.

9. The computer-assisted method according to claim 2, wherein at least one of the second number of display positions is associated with a store exchange card for sale, and the method further comprises:
refreshing, in response to receiving an operation of purchasing the store exchange card, the second store interface to display a third store interface, wherein the third store interface is a store interface of an enemy user account and comprises second chess piece; and
causing to be output for display the second chess piece in the chess piece candidate area of the turn-based chess game in response to receiving an operation of purchasing the second chess piece via the third store interface.

10. The computer-assisted method according to claim 9, wherein the refreshing the second store interface to display a third store interface comprises:
sending a store exchange request to a server, wherein the store exchange request comprises a request to exchange stores of two parties of the battle;
receiving a store exchange instruction sent by the server, wherein the store exchange instruction comprises the third store interface of the enemy user account; and
refreshing the second store interface to display the third store interface according to the store exchange instruction.

11. An apparatus comprising:
one or more processors; and
memory storing computer-readable instructions that when executed by the one or more processors, cause the apparatus to:
generate, for a battle of a turn-based chess game comprising a first-level store selling chess pieces used in the turn-based chess game and a second-level store selling chess pieces used in the turn-based chess game, a first store interface of the first-level store, wherein the first-level store corresponds to a first functional area combination and the second-level store corresponds to a second functional area combination, and wherein the first store interface displays the first functional area combination in an unlocked state, a difference between the second functional area combination and the first functional area combination in a locked state, and a prompt for upgrading the first-level store to unlock the difference;
cause the first store interface to be output for display;
generate a second store interface of the second-level store in response to receiving one or more user inputs resulting in an upgrade from the first-level store to the second-level store, the second store interface displaying the difference in the unlocked state;
cause the second store interface to be output for display;
receive, via the second store interface, an operation to purchase a first chess piece; and
cause to be output, for display and based on the receiving, the first chess piece in a chess piece candidate area of the battle of the turn-based chess game.

12. The apparatus according to claim 11, wherein:
the first functional area combination comprises a first number of display positions,
the second functional area combination comprises the first number of display positions and a second number of display positions,
the difference comprises the second number of display positions, and
the generating the second store interface comprises unlocking the second number of display positions on the first store interface to generate the second store interface of the second-level store.

13. The apparatus according to claim 12, wherein the unlocking comprises:
based on a difference between the second functional area combination corresponding to the second-level store and a third functional area combination corresponding to a third-level store, unlock the second number of display positions on the first store interface, and add display of the difference between the second functional area combination and the third functional area combination, wherein the first store interface further displays a prompt for upgrading the first-level store to unlock the difference between the second functional area combination and the third functional area combination.

14. The apparatus according to claim 11, the memory storing computer-readable instructions that when executed by the one or more processors, further cause the apparatus to:
based on the upgrade, cause to be output for display a refreshed first store interface.

15. The apparatus according to claim 14, the memory storing computer-readable instructions that when executed by the one or more processors, further cause the apparatus to:
generate the refreshed first store interface by refreshing, according to a first chess piece refresh probability corresponding to the first-level store, a chess piece sold by the first-level store; and
generate a refreshed second store interface by refreshing, according to a second chess piece refresh probability corresponding to the second-level store, a chess piece sold by the second-level store,
wherein an appearance probability of a first-grade chess piece based on the first chess piece refresh probability is lower than an appearance probability of the first-grade chess piece based on the second chess piece refresh probability, and
wherein an appearance probability of a second-grade chess piece based on the first chess piece refresh probability is higher than an appearance probability of the second-grade chess piece based on the second chess piece refresh probability.

16. A non-transitory computer-readable medium storing computer-readable instructions that when executed by one or more processors, cause the one or more processors to:
generate, for a battle of a turn-based chess game comprising a first-level store selling chess pieces used in the turn-based chess game and a second-level store selling chess pieces used in the turn-based chess game, a first store interface of the first-level store, wherein the first-level store corresponds to a first functional area combination and the second-level store corresponds to a second functional area combination, and wherein the first store interface displays the first functional area combination in an unlocked state, a difference between the second functional area combination and the first functional area combination in a locked state, and a prompt for upgrading the first-level store to unlock the difference;
cause the first store interface to be output for display;
generate a second store interface of the second-level store in response to receiving one or more user inputs resulting in an upgrade from the first-level store to the second-level store, the second store interface displaying the difference in the unlocked state;
cause the second store interface to be output for display;
receive, via the second store interface, an operation to purchase a first chess piece; and
cause to be output, for display and based on the receiving, the first chess piece in a chess piece candidate area of the battle of the turn-based chess game.

17. The non-transitory computer-readable medium according to claim 16, wherein:
the first functional area combination comprises a first number of display positions,
the second functional area combination comprises the first number of display positions and a second number of display positions,
the difference comprises the second number of display positions, and
the generating the second store interface comprises unlocking the second number of display positions on the first store interface to generate the second store interface of the second-level store.

18. The non-transitory computer-readable medium according to claim 17, wherein the unlocking comprises:
based on a difference between the second functional area combination corresponding to the second-level store and a third functional area combination corresponding to a third-level store, unlock the second number of display positions on the first store interface, and add display of the difference between the second functional area combination and the third functional area combination, wherein the first store interface further displays a prompt for upgrading the first-level store to unlock the difference between the second functional area combination and the third functional area combination.

19. The non-transitory computer-readable medium according to claim 16, further comprising computer-readable instructions that when executed by the one or more processors, cause the one or more processors to:
based on the upgrade, cause to be output for display a refreshed first store interface.

20. The non-transitory computer-readable medium according to claim 19, further comprising computer-readable instructions that when executed by the one or more processors, cause the one or more processors to:
generate the refreshed first store interface by refreshing, according to a first chess piece refresh probability corresponding to the first-level store, a chess piece sold by the first-level store; and
generate a refreshed second store interface by refreshing, according to a second chess piece refresh probability corresponding to the second-level store, a chess piece sold by the second-level store,
wherein an appearance probability of a first-grade chess piece based on the first chess piece refresh probability is lower than an appearance probability of the first-grade chess piece based on the second chess piece refresh probability, and
wherein an appearance probability of a second-grade chess piece based on the first chess piece refresh probability is higher than an appearance probability of the second-grade chess piece based on the second chess piece refresh probability.
